(19) United States
(12) Patent Application Publication
(10) Pub. No.: US 2026/0187858 A1
(43) Pub. Date: Jul. 2, 2026

(54) METHOD, APPARATUS, DEVICE AND STORAGE MEDIUM FOR GENERATING MEDIA CONTENT

(71) Applicant: Lemon Inc., Grand Cayman (KY)

(72) Inventors: Qing YAN, Los Angeles, CA (US); Xiao Yang, Beijing (CN)

(21) Appl. No.: 19/429,724

(22) Filed: Dec. 22, 2025

(30) Foreign Application Priority Data
Dec. 31, 2024 (CN) 202411999529.9

(51) Int. Cl. G06T 11/00; G06N 3/0475; G06N 3/094; G06T 5/70

(52) U.S. Cl. CPC G06T 11/00; G06N 3/0475; G06N 3/094; G06T 5/70; G06T 2207/20182

(57) ABSTRACT

A method, an apparatus, an electronic device and a storage medium for generating media content are provided. The method comprises: obtaining a prompt; and processing the prompt using a media generation model, to generate media content associated with a first effect and a second effect, where the media generation model is constructedbased on: processing a training prompt using a first model associated with the first effect, to generate a first feature representation; processing the training prompt using a second model associated with the second effect, to generate a second feature representation; processing the first feature representation and the second feature representation using a discriminator to determine an adversarial loss; and adjusting, based on the adversarial loss, parameters of the first model to construct a media generation model.

### CROSS REFERENCE

This application claims the benefit of Chinese Patent Application No. 202411999529.9, filed on December 31, 2024, entitled “METHOD, APPARATUS, DEVICE AND STORAGE MEDIUM FOR GENERATING MEDIA CONTENT”, the entire contents of which are incorporated herein by reference.

### FIELD

Example embodiments of the present disclosure generally relate to the field of computers, and in particular, to a method, an apparatus, a device, and a computer-readable storage medium for generating media content.

### BACKGROUND

With the development of computer levels, machine learning models are widely used in various fields such as image processing. Specifically, a machine learning model may be used to generate images, process images, or beautify images. In some scenarios, people usually use a machine learning model to generate required image materials when people cannot collect the required image materials.

However, image materials generated using the machine learning model sometimes cannot meet the requirements of people for image quality.

### SUMMARY

In a first aspect of the present disclosure, a method of generating media content is provided. The method comprises: obtaining a prompt; and processing the prompt using a media generation model, to generate media content associated with a first effect and a second effect, where the media generation model is constructed based on: processing a training prompt using a first model associated with the first effect, to generate a first feature representation; processing the training prompt using a second model associated with the second effect, to generate a second feature representation; processing the first feature representation and the second feature representation using a discriminator to determine an adversarial loss; and adjusting, based on the adversarial loss, parameters of the first model to construct a media generation model.

In a second aspect of the present disclosure, an apparatus for generating media content is provided. The apparatus comprises: an obtaining module configured to obtain a prompt; and a generation module configured to process the prompt using a media generation model, to generate media content associated with a first effect and a second effect, where the media generation model is constructed based on: processing the training prompt using a first model associated with the first effect, to generate a first feature representation; processing the training prompt using a second model associated with the second effect, to generate a second feature representation; processing the first feature representation and the second feature representation using a discriminator to determine an adversarial loss; and adjusting, based on the adversarial loss, parameters of the first model to construct a media generation model.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, causing the device to perform the method of the first aspect.

In a fourth aspect of the present disclosure, a computer-readable storage medium is provided. The computer-readable storage medium has a computer program stored thereon the computer program being executable by the processor to implement the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description in conjunction with the accompanying drawings. In the drawings, the same or similar reference numbers refer to the same or similar elements, where:

FIG. 1 shows a schematic diagram of an example environment in which embodiments in accordance with the present disclosure may be implemented;

FIG. 2A to FIG. 2B show example interfaces in accordance with some embodiments of the present disclosure;

FIG. 3 shows a flowchart of an example process of generating media content in accordance with some embodiments of the present disclosure;

FIG. 4 shows a flowchart of an example process of constructing a media generation model according to some embodiments of the present disclosure;

FIG. 5 shows a flowchart of an example process of constructing a media generation model in accordance with some embodiments of the present disclosure;

FIG. 6 shows a schematic structural block diagram of an example apparatus for generating media content in accordance with some embodiments of the present disclosure; and

FIG. 7 shows a block diagram of an electronic device capable of implementing a plurality of embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be illustrated as limited to the embodiments set forth herein, but rather, these embodiments are provided for a more thorough and complete understanding of the present disclosure. It should be understood that the accompanying drawings and embodiments of the present disclosure are for illustration purposes only and are not intended to limit the scope of the present disclosure.

It should be noted that the title of any section/subsection provided herein is not limiting. Various embodiments are described throughout herein and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or same objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, collection, acquisition, processing, refinement, forwarding, using and the like of data are all performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

The solutions in the present specification and the embodiments, if personal information processing is involved, may perform processing on the premise of having a legality basis (for example, obtaining consent of a personal information subject, or necessary for performing a fulfillment contract), and processing only within a specified or agreed range. The user rejection on processing personal information other than necessary information required by the basic function does not affect a use of the basic function by the user.

As mentioned above, people usually need to collect some image materials of the same type or the same subject as a basis for operations such as model training. When people cannot collect the required image material or cannot collect sufficient image material, the machine learning model can be used to generate the required image material. However, the image material generated by the machine learning model cannot meet the requirements of people for the image quality of the image material.

Embodiments of the present disclosure provide a solution for generating media content. The method comprises: obtaining a prompt; and processing the prompt using a media generation model, to generate media content associated with a first effect and a second effect, where the media generation model is constructed based on the following process: processing a training prompt using a first model associated with the first effect, to generate a first feature representation; processing the training prompt using a second model associated with the second effect, to generate a second feature representation; processing the first feature representation and the second feature representation using a discriminator to determine an adversarial loss; and adjusting, based on the adversarial loss, parameters of the first model to construct a media generation model.

In this way, the embodiments of the present disclosure enable the first model to learn the second effect in the second model on the basis of retaining the first effect, thereby constructing a media generation model having the first effect and the second effect. This enables improvement of the image quality of the image material generated by using the media generation model.

Various example implementations of this solution are described in detail below in conjunction with the accompanying drawings.

### Example Environment

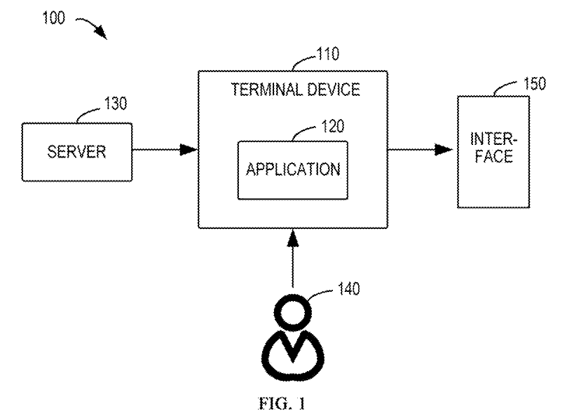

FIG. 1 shows a schematic diagram of an example environment 100 in which embodiments of the present disclosure can be implemented. As shown in FIG. 1, the example environment 100 may include a terminal device 110.

In this example environment 100, the terminal device 110 may run an application 120 that supports generating media content. The application 120 may be any suitable type of applications for generating media content, examples of which may include, but are not limited to, image processing applications or other suitable applications. A user 140 may interact with the application 120 via the terminal device 110 and/or its attachment device.

In the environment 100 of FIG. 1, if the application 120 is in an active state, the terminal device 110 may present, through the application 120, an interface 150 for supporting generation of the media content.

In some embodiments, the terminal device 110 communicates with a server 130 to enable provisioning of the services to the application 120. The terminal device 110 may be any type of mobile terminals, fixed terminals, or portable terminals, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination thereof, including accessories and peripherals of these devices, or any combination thereof. In some embodiments, the terminal device 110 can also support any type of interfaces (such as a “wearable” circuit, and/or the like ) for the user 140.

The server 130 may be an independent physical server, may be a server cluster or a distributed system comprising multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a backend service for the application 120 that supports the generation of the media content in the terminal device 110.

A communication connection may be established between the server 130 and the terminal device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In the embodiment of the present disclosure, the server 130 and the terminal device 110 may implement signaling interaction through the communication connection between the server 130 and the terminal device 110.

It should be understood that the structures and functions of the various elements in the environment 100 are described for illustration purposes only and do not imply any limitation to the scope of the present disclosure.

Some example embodiments of the present disclosure will be described below with continued reference to the accompanying drawings.

### Example Interaction

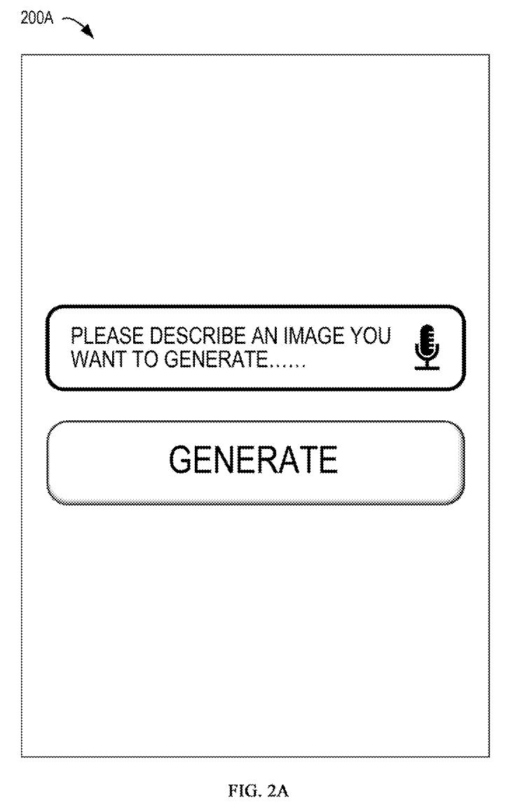

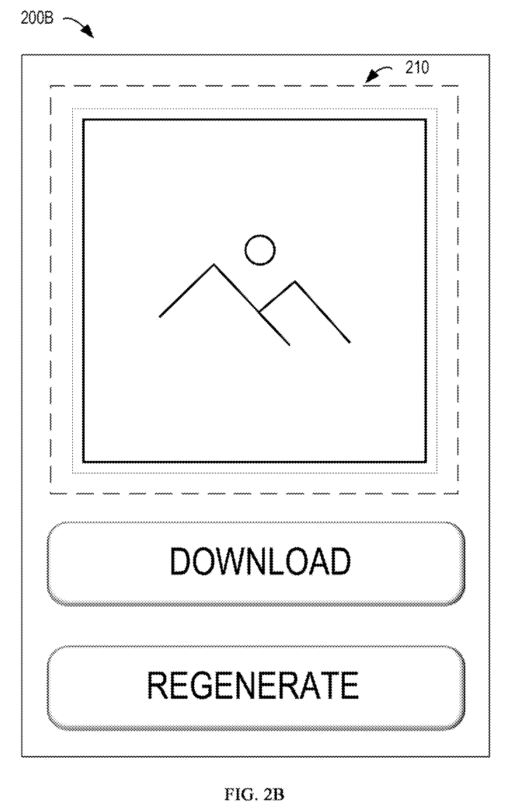

FIGS. 2A to 2B show example interfaces 200A to 200B in accordance with some embodiments of the present disclosure. The interfaces 200A to 200B may be provided by, for example, the terminal device 110 shown in FIG. 1.

As shown in FIG. 2A, in some embodiments, the application 120 may provide functionality to generate media content. As an example, a main interface of the application 120 may be configured with a corresponding control. The user 140 may use the functionality of generating media content in the application 120 by clicking on a control. Specifically, when receiving the operation information indicating that the user 140 clicks on the control, the terminal device 110 may present the interface 200A. The interface 200A is configured to allow the user 140 to input a prompt.

In some embodiments, the interface 200A may include an input box for the user 140 to enter a prompt and a control for the generation of the media content. Herein, the input box may display a prompt text for prompting the user 140. The prompt text may be, for example, “Please describe an image you want to generate……”. The terminal device 110 may support various input manners such as a handwriting input and a voice input, so that the user 140 inputs a prompt. Additionally, the input box may be configured with a control for the voice input, so that the user 140 inputs the prompt in a voice input manner. A control for generating media content may, for example, display a “generate” text.

Further, after the user 140 inputs the prompt in the input box, the terminal device 110 may display the interface 200B shown in FIG. 2B after receiving the operation information indicating that the user 140 clicks the control for the generation of the media content. The terminal device 110 may display information related to the media content through the interface 200B to provide the media content. As an example, the information related to the media content may be at least one of a preview image of the media content or a download link of the media content.

As shown in FIG. 2B, in some embodiments, the interface 200B may include a preview area 210 for the user 140 to preview the media content and a control for the user 140 to download the media content. Herein, the control for the user 140 to download the media content may, for example, display a “download” text.

Additionally, the interface 200B may also include a control for regeneration of the media content. The control may, for example, display a “regenerate” text. When the user 140 is not satisfied with the media content in the preview area 210, the application 120 may be caused by a control for the regeneration of the media content, to regenerate the media content based on the prompt. Specifically, when the terminal device 110 receives the operation information indicating that the user 140 clicks on the control for the regeneration of the media content, the terminal device 110 causes the application 120 to regenerate the media content based on the prompt.

It should be understood that the media content generation interfaces shown in FIGS. 2A to 2B are merely examples, and other suitable interfaces may be used to generate and provide media content. Graphical elements in the interface may have different arrangements and different visual representations, one or more element(s) of which may be omitted or replaced, and one or more other element(s) may also be present. Embodiments of the present disclosure are not limited in this respect.

### Example Processes

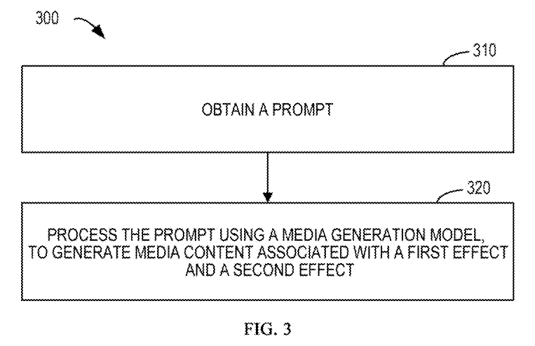

FIG. 3 shows a flowchart of an example process 300 of generating media content, in accordance with some embodiments of the present disclosure. The process 300 may be implemented at the terminal device 110. The process 300 is described below with reference to FIG. 1.

As shown in FIG. 3, at block 310, the terminal device 110 obtains a prompt .

In some embodiments, the prompt may indicate image content, an image style, and the like to be generated. The terminal device 110 may obtain the prompt through an input device communicatively connected to the terminal device 110. The input device may be, for example, a keyboard, a touch screen, or a microphone.

At block 320, the terminal device 110 processes the prompt using the media generation model to generate the media content. The media content is associated with the first effect and the second effect.

In some embodiments, the media content may be an image or a video, which may include a predetermined object. The predetermined object may be, for example, a person, an animal, a plant, an object, or the like. For media content including a predetermined object, both the first effect and the second effect may be effects for a predetermined object. As an example, the first effect may be an effect applied to a component of a predetermined object. The second effect may be an overall effect applied to the predetermined object. Taking a specific example as an example, when the predetermined object in the media content is a character, the first effect may affect the number of facial features and positions of the facial features of the character, and the second effect may affect the overall aesthetic degree of the character.

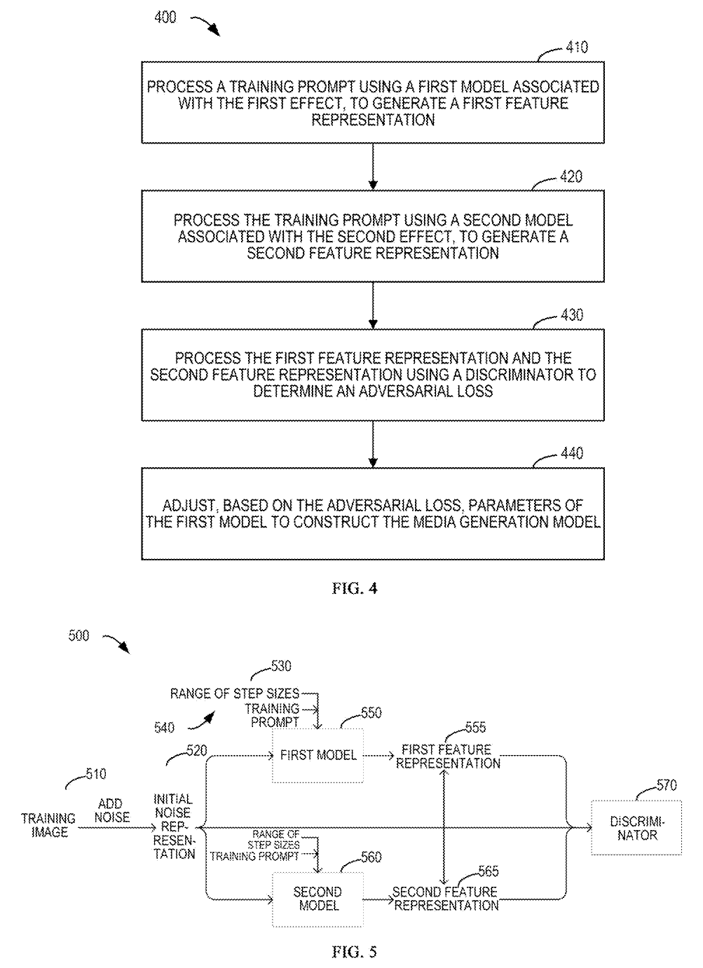

A specific construction process of the media generation model is described below with reference to FIG. 4 and FIG. 5. FIG. 4 shows a flowchart of an example process 400 of constructing a media generation model according to some embodiments of the present disclosure. FIG. 5 shows a flow diagram of an example process 500 for constructing the media generation model according to some embodiments of the present disclosure. It should be understood that the process 400 and/or the process 500 may be performed by an appropriate electronic device, such as the terminal device 110 or the server 130. The process 400 is described below by taking the terminal device 110 as an example.

At block 410, the terminal device 110 processes the training prompt 540 using a first model 550 associated with the first effect to generate a first feature representation 555.

In some embodiments, a training prompt 540 is corresponding to the prompt mentioned above, and may indicate image content, an image style, and the like of the media content to be generated by the first model 550 or a second model 560.

In some embodiments, the first model 550 may be a diffusion model that implements generation of an image based on a text, which may generate media content based on the training prompt 540. The media content generated by the first model 550 may include a first effect. For example, the first effect may cause the number of the facial features and positions of the facial features of the predetermined object in the generated media content to be correct. In this case, in the media content generated by the first model 550, the number of the facial features and the positions of the facial features of the predetermined object are correct.

It should be understood that the principle that the first model 550 generates the media content based on the training prompt 540 is that: the first model 550 generates the initial noise representation 520 first, then performs noise reduction processing associated with the training prompt 540 on an initial noise representation 520, and finally generates the media content corresponding to the training prompt 540. When training the first model 550, the initial noise representation 520 may also be determined based on noise addition processing on a training image 510. The noise intensity of the initial noise representation 520 may be set by setting the first model 550, or by setting a noise addition step size to set the noise intensity of the initial noise representation 520. In this process, whether the media content is clear depends on the step size of the first model 550 for noise reduction processing.

In some embodiments, the first feature representation 555 may be determined based on the initial noise representation 520. Specifically, based on the principle mentioned above, the process in which the terminal device 110 processes the training prompt 540 using the first model 550 to generate the first feature representation 555 may be: performing a first step size noise reduction processing on the initial noise representation 520 using the first model 550 to generate the first feature representation 555. The first step size is determined from a predetermined step size range 530.

As mentioned above, when the first model 550 does not perform noise reduction processing on the initial noise representation 520, the initial noise representation 520 remains in an initial state; when the first model 550 performs noise reduction processing with a maximum step size on the initial noise representation 520, the initial noise representation 520 may form media content after noise reduction processing; and after the first model 550 performs noise reduction processing with a first step size on the initial noise representation 520, the initial noise representation 520 may form the first feature representation 555 after the corresponding noise reduction processing. It can be understood that, when the first step size is a different value in the step size range 530, the first model 550 may generate the first feature representation 555 corresponding to the noise reduction processing with different step sizes. The first feature representation 555 may be an image with a certain noise intensity.

In some embodiments, the step size range 530 may depend on the noise intensity of the initial noise representation 520. For example, if the noise intensity of the initial noise representation 520 is 1000, then the step size range 530 may be 0 to 1000, and the first step size may be any value in 0 to 1000. As an example, the first step size may be any value in 50 to 100, so as to train the first model 550.

Further, when a set of first steps is determined, the first model 550 may generate a corresponding set of the first feature representations 555.

At block 420, the terminal device 110 processes the training prompt 540 with the second model 560 associated with the second effect to generate a second feature representation 565.

In some embodiments, the second model 560 may be the diffusion model implementing the functionality of text-to-image, which may generate the media content based on the training prompt540. The media content generated by the second model 560 may include the second effect. For example, the second effect may make the predetermined object in the generated media content more aesthetic. At this time, the predetermined object is aesthetically pleasing in the media content generated by the second model 560.

The principle that the second model 560 generates the media content based on the training prompt 540 is consistent with the principle that the first model 550 generates the media content based on the training prompt 540, and details are not described herein again. Similarly, the noise intensity of the initial noise representation 520 may be set by setting the second model 560. In addition, whether the media content is clear depends on the step size of the second model 560 for noise reduction processing.

In some embodiments, the second feature representation 565 may be determined based on the initial noise representation 520. Specifically, based on the above principle, the process in which the terminal device 110 processes the training prompt 540 using the second model 560 to generate the second feature representation 565 may be: performing the reduction processing with a second step size on the initial noise representation 520 using the second model 560 to generate the second feature representation 565. The second step size is determined from the predetermined step size range 530.

As the principles mentioned above, when the second model 560 does not perform noise reduction processing on the initial noise representation 520, the initial noise representation 520 remains in an initial state; when the second model 560 performs noise reduction processing with a maximum step size on the initial noise representation 520, the initial noise representation 520 form media content after the noise reduction processing; and after the second model 560 performs noise reduction processing with a second step size on the initial noise representation 520, the initial noise representation 520 may form a second feature representation 565 after the corresponding noise reduction processing. It can be understood that, when the second step is a different value in the step size range 530, the second model 560 may generate the second feature representation 565 corresponding to the noise reduction processing with different step sizes. The second feature representation 565 may be an image with a certain noise intensity.

As an example, when the noise intensity of the initial noise representation 520 is 1000, the step size range 530 may be 0 to 1000, and the second step size may be any value in 0 to 1000. The second step size may be, for example, any value in 50 to 100, so as to train the second model 560.

Further, when a set of second steps is determined, the second model 560 may generate a corresponding set of second feature representations 565.

In some embodiments, the terminal device 110 may perform the steps in block 410 and the steps in block 420 at the same time.

At block 430, the terminal device 110 determines the adversarial loss using the discriminator 570 to process the first feature representation 555 and the second feature representation 565.

In some embodiments, the terminal device 110 may process the first feature representation 555 using the discriminator 570 to generate a first discrimination result, and process the second feature representation 565 using the discriminator 570 to generate a second discrimination result. Where the first determination result indicates that the first feature representation 555 is generated by the first model 550 or the second model 560. The second discrimination result indicates that the second feature representation 565 is generated by the first model 550 or by the second model 560. The terminal device 110 may distinguish the first feature representation 555 and the second feature representation 565 by setting the discriminator 570 to master the extent to which the knowledge of the second model 560 learnt by the first model 550.

In some embodiments, the adversarial loss may indicate whether the first feature representation 555 and the second feature representation 565 are generated by the same model. Specifically, when the first discrimination result is consistent with the second discrimination result, it indicates that the first feature representation 555 and the second feature representation 565 are generated by the same model for the discriminator 570, and then the first feature representation 555 and the second feature representation 565 may be considered to be similar.

It may be understood that, when the terminal device 110 trains the first model 550 and the second model 560 using the same training prompt 540, the first model 550 may learn the knowledge of the second model 560, so that the first feature representation 555 or the media content generated by the first model 550 may not only present the first effect, but also present an additional effect. As the number of training times increases, when the discriminator 570 considers that the first feature representation 555 generated by the first model 550 is similar to the second feature representation 565 generated by the second model 560, it can be indicated that the first feature representation 555 generated by the first model 550 or the additional effect presented by the media content is equivalent to the second effect. At this point, the first model 550 has completely learnt the knowledge of the second model 560.

In some embodiments, the terminal device 110 may determine the adversarial loss based on a difference between the first discrimination result and the second discrimination result. Specifically, the terminal device 110 may quantify the first discrimination result and the second discrimination result to determine a difference between the first discrimination result and the second discrimination result.

As an example, a result of the terminal device 110 quantifying the first discrimination result and the second discrimination result may be determined by the discriminator 570 based on a set of indicators associated with the first feature representation 555 or the second feature representation 565. That is, the terminal device 110 may determine, based on a set of indicators, a parameter value corresponding to the first feature representation 555 or the second feature representation 565.

Specifically, a set of indicators may include, for example, one or more of an initial noise representation(s) 520, a noise addition step corresponding to the initial noise representation 520, a first step size or a second step size, a first feature representation 555 or a second feature representation 565, and a training prompt 540. When the set of indicators correspond to the first feature representation 555, the set of indicators may include the first step size; and when the set of indicators correspond to the second feature representation 565, the set of indicators may include the second step size.

Taking the a set of indicators as an example, which including the initial noise representation 520, the noise addition step size corresponding to the initial noise representation 520, the first step size or the second step size, the first feature representation 555 or the second feature representation 565, and the training prompt 540, the terminal device 110 may determine the parameter value using the initial noise representation 520, the noise addition step size corresponding to the initial noise representation 520, the first step size or the second step size, the first feature representation 555 or the second feature representation 565, and the training prompt 540.

As an example, when determining the parameter value using a set of indicators, the terminal device 110 may perform the following processing on part of the indicator, so as to determine the parameter value: for example, the weighted value corresponding thereto may be determined based on the first feature representation 555 or the second feature representation 565.

Specifically, the weighted value may include a first portion and a second portion. Herein, the first weighting coefficient corresponding to the first step size or the second step size is applied to the first part, and the second weighting coefficient corresponding to the first step size or the second step size is applied to the second part. The first portion may be, for example, a product of the training image 510 and the first weighting coefficient. The second portion may be, for example, a product of the predicted noise representation and the second weighting coefficient, where the predicted noise representation is associated with the preliminary noise representation 520, the noising step size, and the training hint word 540. The predicted noise is represented as a difference between the first feature representation 555 or the second feature representation 565 and the initial noise representation 520. The first weighting coefficient and the second weighting coefficient may be adaptively adjusted according to actual conditions.

The terminal device 110 may determine a parameter value corresponding to the first discrimination result and a parameter value corresponding to the second discrimination result in the manner mentioned above, so as to further determine a difference between them, thereby determine a difference between the first discrimination result and the second discrimination result.

It should be understood that, when there is a set of first step size, a set of first feature representations 555 are correspondingly generated. When there is a set of second step sizes, a set of second feature representations 565 are correspondingly generated. When the terminal device 110 divides the first feature representation 555 and the second feature representation 565 corresponding to the same first step size and the second step size into a feature pair, a set of feature pairs and a corresponding set of difference values may be obtained. As an example, the terminal device 110 may determine a minimum value in the set of differences as the adversarial loss.

At block 440, the terminal device 110 adjusts parameters of the first model 550 based on the adversarial loss to construct a media generation model.

In some embodiments, the terminal device 110 may adjust a parameter of the first model 550 based on the adversarial loss and the generation loss associated with the first model 550. Herein, the generation loss indicates that the first feature representation 555 is considered to be generated by the second model 560.

As an example, the process of determining the generation loss by the terminal device 110 may be: first, determining a parameter value based on a group of indicators corresponding to the first feature representation 555; and then, determining the generation loss based on the parameter value. Herein, the parameter value determined by the set of indicators corresponding to the first feature representation 555 may be the parameter value mentioned above. The process of determining the parameter value is consistent with the process mentioned above, and details are not described herein again.

It should be understood that when there is a set of first step sizes, a set of first feature representations 555 are correspondingly generated. According to the computation manner mentioned above, the terminal device 110 may determine a set of parameter values corresponding to the set of first feature representations 555. As an example, the terminal device 110 may determine a maximum value of a set of parameter values as the generation loss.

Further, the terminal device 110 may adjust the parameters of the first model 550by maximizing training the generation, loss and minimizing the training adversarial loss until the training converges. The trained first model 550 can not only maintain the first effect but also learn the knowledge of the second model 560 to achieve the second effect. The media generation model may be constructed using the trained first model 550, so that the media content generated by the media generation model has the first effect and the second effect at the same time, thereby improving the image quality of the generated media content.

### Example Apparatus and Device

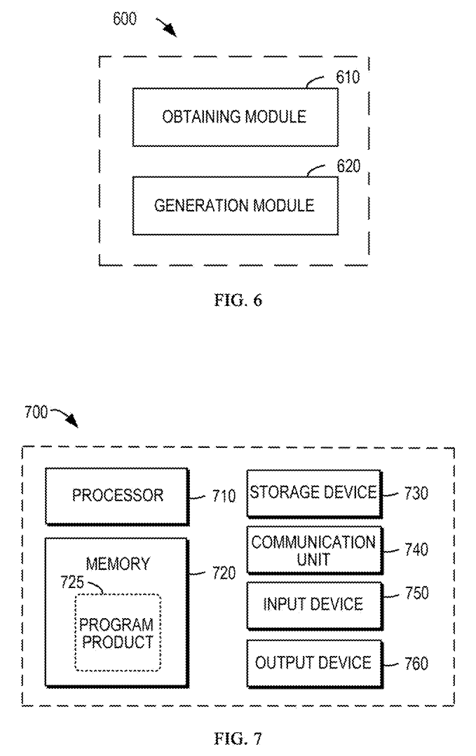

Embodiments of the present disclosure also provide a corresponding apparatus for implementing the method or process mentioned above. FIG. 6 shows a schematic structural block diagram of an example apparatus 600 for the generation of the media content in accordance with some embodiments of the present disclosure. The apparatus 600 may be implemented or be included in the terminal device 110. The various modules/components in the apparatus 600 may be implemented by hardware, software, firmware, or any combination thereof.

As shown in FIG. 6, the apparatus 600 includes: an obtaining module 610 configured to obtain a prompt; and a generation module 620 configured to process the prompt using the media generation model, to generate media content associated with the first effect and the second effect, where the media generation model is constructed based on: processing the training prompt using a first model associated with the first effect, to generate the first feature representation; processing the training prompt by using the second model associated with the second effect, to generate the second feature representation; processing the first feature representation and the second feature representation using the discriminator to determine the adversarial loss; and, adjusting, based on the adversarial loss, a parameter of the first model to construct the media generation model.

In some embodiments, the first model and the second model are diffusion models, and the first feature representation and the second feature representation are further determined based on an initial noise representation, the initial noise representation being determined based on the noise addition processing on the training image.

In some embodiments, the first feature representation is generated after performing the noise reduction processing with the first step size on the initial noise representation by the first model, and the second feature representation is generated after performing noise reduction with the second step size processing on the initial noise representation by the second model.

In some embodiments, the first step size and the second step size are determined from a predetermined step size range.

In some embodiments, the adversarial loss is further determined by the discriminator based on at least one of: an initial noise representation; an noise addition step size corresponding to the initial noise representation; the first step size or the second step size; and the training prompt.

In some embodiments, adjusting the parameter of the first model based on the adversarial loss includes: adjusting the parameter of the first model based on the adversarial loss and the generation loss associated with the first model.

In some embodiments, processing the first feature representation and the second feature representation using the discriminator to determine the adversarial loss includes: processing the first feature representation using the discriminator to generate a first discrimination result; processing the second feature representation using the discriminator to generate a second discrimination result; and determining the discrimination loss based on a difference between the first discrimination result and the second discrimination result.

In some embodiments, the adversarial loss indicates whether the first feature representation and the second feature representation are generated by the same model.

As shown in FIG. 7, the electronic device 700 is in the form of a general-purpose electronic device. Components of the electronic device 700 may include, but are not limited to, one or more processor(s) or processing units 710, a memory 720, a storage device 730, one or more communication unit(s) 740, one or more input device(s) 750, and one or more output device(s) 760. The processing unit 710 may be an actual or virtual processor, and capable of performing various processes according to programs stored in the memory 720. In multiprocessor systems, multiple processing units execute computer-executable instructions in parallel to improve parallel processing capabilities of electronic device 700.

Electronic device 700 typically includes a plurality of computer storage medium. Such medium may be any available medium accessible to the electronic device 700, including, but not limited to, volatile and non-volatile medium, removable and non-removable medium. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage medium. Although not shown in FIG. 7, a magnetic disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data medium interface(s). The memory 720 may include a computer program product 725 having one or more program module(s) configured to perform various methods or actions of various embodiments of the present disclosure.

The communication unit 740 is configured to communicate with another electronic device through a communication medium. Additionally, the functionality of components of the electronic device 700 may be implemented by a single computing cluster or multiple computing machines capable of communicating over a communication connection. Thus, the electronic device 700 may operate in a networked environment using logical connections with one or more other server(s), network personal computers (PCs), or another network node.

The input device 750 may be one or more input device(s), such as a mouse, a keyboard, a trackball, or the like. The output device 760 may be one or more output device(s), such as a display, a speaker, a printer, or the like. The electronic device 700 may also communicate with one or more external device(s) (not shown), such as, storage devices, display devices, and the like. , through the communication unit 740 as needed, communicate with one or more device(s) that enable a user to interact with the electronic device 700, or communicate with any device (e.g., a network card, a modem, etc. ) that enables the electronic device 700 to communicate with one or more other electronic device(s). Such communication may be performed via an input/output (I/O) interface (not shown).

According to illustration implementations of the present disclosure, there is provided a computer-readable storage medium having computer-executable instructions stored thereon, where the computer-executable instructions are executed by a processor to implement the method described above. According to illustration implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general-purpose computer, special-purpose computer, or other programmable data processing apparatus to produce a machine, such that the instructions, when executed by a processing unit of a computer or other programmable data processing apparatus, produce apparatus to implement the functions/actions specified in the one or more block(s) in the flowcharts and/or block diagrams. These computer-readable program instructions may also be stored in a computer-readable storage medium, which cause the computer, programmable data processing apparatus, and/or other devices to function in a particular manner, such that the computer-readable medium storing instructions includes an article of manufacture including instructions to implement aspects of the functions/actions specified in the one or more block(s) in the flowcharts and/or block diagrams.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/actions specified in the one or more block(s) in the flowchart and/or block diagram.

The flowcharts and block diagrams in the accompanying drawings show architecture, functionality, and operation of possible implementations of systems, methods, and computer program products in accordance with various implementations of the present disclosure. In this regard, each block in the flowcharts or block diagrams may represent a module, program segment, or portion of an instruction that includes one or more executable instruction(s) for implementing the specified logical function. In some alternative implementations, the functions noted in the blocks may also occur in a different order than noted in the accompanying drawings. For example, two consecutive blocks may actually be performed substantially in parallel, which may sometimes be performed in reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various illustrated implementations. The selection of the terms used herein is intended to best explain the principles of the implementations, practical applications, or improvements to techniques in the marketplace, or to enable others of ordinary skill in the art to understand the various implementations disclosed herein.

1. A method for generating media content, comprising:
obtaining a prompt; and
processing the prompt using a media generation model, to generate media content associated with a first effect and a second effect, wherein the media generation model is constructed based on:
processing a training prompt using a first model associated with the first effect, to generate a first feature representation;
processing the training prompt using a second model associated with the second effect, to generate a second feature representation;
processing the first feature representation and the second feature representation using a discriminator to determine an adversarial loss; and
adjusting, based on the adversarial loss, parameters of the first model to construct the media generation model.

2. The method of claim 1, wherein the first model and the second model are diffusion models, and the first feature representation and the second feature representation are further determined based on an initial noise representation, the initial noise representation being determined based on noise addition processing on a training image.

3. The method of claim 2, wherein the first feature representation is generated after performing, by the first model, noise reduction processing of a first step size on the initial noise representation, and the second feature representation is generated after performing, by the second model, performing noise reduction processing of a second step size on the initial noise representation.

4. The method of claim 3, wherein the first step size and the second step size are determined from a predetermined range of step sizes.

5. The method of claim 2, wherein the adversarial loss is further determined by the discriminator based on at least one of:
the initial noise representation;
a noising step corresponding to the initial noise representation;
the first step size or the second step size;
the training prompt.

6. The method of claim 1, wherein adjusting the parameters of the first model based on the adversarial loss comprises:
adjusting the parameters of the first model based on the adversarial loss and a generation loss associated with the first model.

7. The method of claim 1, wherein processing the first feature representation and the second feature representation using the discriminator to determine the adversarial loss comprises:
processing the first feature representation using the discriminator to generate a first discrimination result;
processing the second feature representation using the discriminator to generate a second discrimination result; and
determining the adversarial loss based on a difference between the first discrimination result and the second discrimination result.

8. The method of claim 1, wherein the adversarial loss indicates whether the first feature representation and the second feature representation are generated by a same model.

9. An electronic device, comprising:
at least one processing unit; and
at least one memory coupled to the at least one processing unit and storing instructions for execution by the at least one processing unit, the instructions, when executed by the at least one processing unit, causing the electronic device to perform operations comprising::
obtaining a prompt; and
processing the prompt using a media generation model, to generate media content associated with a first effect and a second effect, wherein the media generation model is constructed based on:
processing a training prompt using a first model associated with the first effect, to generate a first feature representation;
processing the training prompt using a second model associated with the second effect, to generate a second feature representation;
processing the first feature representation and the second feature representation using a discriminator to determine an adversarial loss; and
adjusting, based on the adversarial loss, parameters of the first model to construct the media generation model.

10. The electronic device of claim 9, wherein the first model and the second model are diffusion models, and the first feature representation and the second feature representation are further determined based on an initial noise representation, the initial noise representation being determined based on noise addition processing on a training image.

11. The electronic device of claim 10, wherein the first feature representation is generated after performing, by the first model, noise reduction processing of a first step size on the initial noise representation, and the second feature representation is generated after performing, by the second model, performing noise reduction processing of a second step size on the initial noise representation.

12. The electronic device of claim 11, wherein the first step size and the second step size are determined from a predetermined range of step sizes.

13. The electronic device of claim 10, wherein the adversarial loss is further determined by the discriminator based on at least one of:
the initial noise representation;
a noising step corresponding to the initial noise representation;
the first step size or the second step size;
the training prompt.

14. The electronic device of claim 9, wherein adjusting the parameters of the first model based on the adversarial loss comprises:
adjusting the parameters of the first model based on the adversarial loss and a generation loss associated with the first model.

15. The electronic device of claim 9, wherein processing the first feature representation and the second feature representation using the discriminator to determine the adversarial loss comprises:
processing the first feature representation using the discriminator to generate a first discrimination result;
processing the second feature representation using the discriminator to generate a second discrimination result; and
determining the adversarial loss based on a difference between the first discrimination result and the second discrimination result.

16. The electronic device of claim 9, wherein the adversarial loss indicates whether the first feature representation and the second feature representation are generated by a same model.

17. A computer program product tangibly stored on a computer readable storage medium and comprising instructions, the instructions, when executed by a device, causing the device to perform operations comprising:
obtaining a prompt; and
processing the prompt using a media generation model, to generate media content associated with a first effect and a second effect, wherein the media generation model is constructed based on:
processing a training prompt using a first model associated with the first effect, to generate a first feature representation;
processing the training prompt using a second model associated with the second effect, to generate a second feature representation;
processing the first feature representation and the second feature representation using a discriminator to determine an adversarial loss; and
adjusting, based on the adversarial loss, parameters of the first model to construct the media generation model.

18. The computer program product of claim 17, wherein the first model and the second model are diffusion models, and the first feature representation and the second feature representation are further determined based on an initial noise representation, the initial noise representation being determined based on noise addition processing on a training image.

19. The computer program product of claim 18, wherein the first feature representation is generated after performing, by the first model, noise reduction processing of a first step size on the initial noise representation, and the second feature representation is generated after performing, by the second model, performing noise reduction processing of a second step size on the initial noise representation.

20. The computer program product of claim 19, wherein the first step size and the second step size are determined from a predetermined range of step sizes.
